(19) United States
(12) Patent Application Publication
(10) Pub. No.: US 2019/0168308 A1
(43) Pub. Date: Jun. 6, 2019

(54) METHOD FOR PRODUCING COPPER POWDER

(71) Applicant: ADEKA CORPORATION, Tokyo (JP)

(72) Inventors: Yusuke NUIDA, Tokyo (JP); Hiroshi MORITA, Tokyo (JP)

(73) Assignee: ADEKA CORPORATION, Tokyo (JP)

(21) Appl. No.: 16/321,541

(22) PCT Filed: Jul. 5, 2017
(86) PCT No.: PCT/JP2017/024661

§ 371 Date: Jan. 29, 2019

(30) Foreign Application Priority Data
Aug. 3, 2016 (JP) 2016-152693

(51) Int. Cl. B22F 9/20

(52) U.S. Cl. CPC B22F 9/20; B22F 2304/058; H01B 1/02; B22F 2301/10; B22F 2304/10

(57) ABSTRACT

Provided is a method for producing copper powder, including using, as raw materials, (A) cuprous oxide, (B) at least one selected from the group consisting of boric acid and salts thereof, (C) at least one selected from the group consisting of ammonia and an ammonium ion source, and (D) at least one selected from the group consisting of monosaccharides, disaccharides, and polysaccharides. Component (C) preferably includes at least one selected from the group consisting of ammonia, ammonium chloride, ammonium bromide, ammonium formate, and ammonium acetate.

### TECHNICAL FIELD

The present invention relates to a method for producing copper powder. More specifically, the present invention relates to a method for producing copper powder that can be used as a conductive material for various applications, such as a conductive filler to be blended into a conductive paste that is used for forming electric circuits, external electrodes of ceramic capacitors, or the like.

### BACKGROUND ART

Copper powder has been widely used as a conductive material of a conductive paste for forming conductive portions (for example, an electrode or a circuit) of electronic components. A wet reduction method has been generally known as a method for producing the copper powder.

For example, in Patent Document 1, there is disclosed a method of obtaining copper powder having a minor axis of less than 100 nm and a major axis of less than 100 nm, the method involving using hydrazine or a hydrazine compound as a reducing agent when reducing copper hydroxide in a liquid to metal copper particles through use of the reducing agent, performing the reduction reaction in the presence of a defoaming agent, and adding a surface treatment agent before, after, or during the reduction reaction.

Further, in Patent Document 2, there is disclosed a method for producing copper powder, the method involving: performing first reduction treatment through addition of a reducing agent to a copper hydroxide slurry obtained by allowing a copper ion-containing aqueous solution and an alkali solution to react with each other, to thereby provide a cuprous oxide slurry; allowing the cuprous oxide slurry to stand to precipitate cuprous oxide particles; cleaning the cuprous oxide particles through removal of a supernatant from the resultant and addition of water thereto, to thereby provide a cleaned cuprous oxide slurry; and performing a second reduction treatment through addition of a reducing agent to the cleaned cuprous oxide slurry. In this method, the first reduction treatment includes adding hydrazine serving as a reducing agent and an ammonia aqueous solution serving as a pH adjuster in combination to the copper hydroxide slurry, to thereby provide copper powder formed of fine and uniform particles.

Patent Document 1: JP 2004-211108 A

Patent Document 2: JP 2007-254846 A

### SUMMARY OF INVENTION

### Technical Problem

When copper powder having an average particle diameter D₅₀ (particle diameter at an accumulation of 50% in a volume accumulation distribution) of from 0.5 μm to 10 μm is produced through use of the related-art production methods as described above, there is a problem in that the volume resistivity of a conductive portion to be formed through use of the copper powder becomes large.

The present invention has been made to solve the above-mentioned problem, and an object of the present invention is to provide a method for producing copper powder which can form a conductive portion having a low volume resistivity even when having an average particle diameter D₅₀ of from 0.5 μm to 10 μm.

### Solution to the Problem

The inventors of the present invention have repeatedly conducted extensive investigations, and as a result, have found that the above-mentioned problem can be solved through use of specific raw materials in the method for producing copper powder, to thereby achieve the present invention.

That is, according to one embodiment of the present invention, there is provided a method for producing copper powder, including using, as raw materials, (A) cuprous oxide, (B) at least one selected from the group consisting of boric acid and salts thereof, (C) at least one selected from the group consisting of ammonia and an ammonium ion source, and (D) at least one selected from the group consisting of monosaccharides, disaccharides, and polysaccharides.

### Advantageous Effects of the Invention

According to the present invention, the method for producing copper powder which can form a conductive portion having a low volume resistivity even when having an average particle diameter D₅₀ of from 0.5 μm to 10 μm can be provided.

### DESCRIPTION OF EMBODIMENTS

A method for producing copper powder of the present invention has a feature of using components (A) to (D) as raw materials.

Component (A) is cuprous oxide. Cuprous oxide is synonymous with copper (I) oxide. As component (A), commercially available cuprous oxide may be used, or cuprous oxide produced by reducing a copper salt of an inorganic acid, such as copper sulfate, may be used.

Component (B) is at least one selected from the group consisting of boric acid and salts thereof. There is no particular limitation on the salts of boric acid, and examples thereof include lead borate, barium borate, zinc borate, aluminum borate, sodium tetraborate, and hydrates thereof. As component (B), only one of the components may be used, or two or more of the components may be used in combination. Of those, it is preferred that boric acid be used as component (B) because copper powder capable of forming a conductive portion having a low volume resistivity is easily obtained. It is more preferred that only boric acid be used as component (B) because the above-mentioned effect is particularly enhanced.

The amount of component (B) to be used is appropriately set in accordance with, for example, the kind of component (B) to be used, and there is no particular limitation on the usage amount. The usage amount is preferably from 0.05 mole to 2.0 moles, more preferably from 0.1 mole to 1.0 mole with respect to 1 mole of component (A). When the usage amount of component (B) falls within the above-mentioned range, copper powder capable of forming a conductive portion having a low volume resistivity is easily obtained.

Component (C) is at least one selected from the group consisting of ammonia and an ammonium ion source. The ammonium ion source is not particularly limited as long as the ammonium ion source is a compound that can supply ammonium ions, and examples thereof include ammonium chloride, ammonium bromide, ammonium formate, ammonium sulfate, ammonium nitrate, ammonium carbonate, ammonium acetate, ammonium maleate, ammonium citrate, ammonium tartrate, and ammonium malate. As component (C), only one of the components may be used, or two or more of the components may be used in combination. Of those, it is preferred that at least one selected from the group consisting of ammonia, ammonium chloride, ammonium bromide, ammonium formate, and ammonium acetate be used as component (C) because flat copper powder having a satisfactory filling property are obtained and a conductive portion having a low volume resistivity is easily formed.

The amount of component (C) to be used is appropriately set in accordance with, for example, the kind of component (C) to be used, and there is no particular limitation on the usage amount. The usage amount is preferably from 0.05 mole to 5.0 moles, more preferably from 0.1 mole to 3.0 moles with respect to 1 mole of component (A). When the usage amount of component (C) falls within the above-mentioned range, copper powder capable of forming a conductive portion having a low volume resistivity is easily obtained.

Further, the ratio between component (B) and component (C) is appropriately set in accordance with, for example, the kind of each component to be used, but the ratio is preferably from 1:0.1 to 1:10 in a molar ratio. When the ratio between component (B) and component (C) falls within the above-mentioned range, copper powder capable of forming a conductive portion having a low volume resistivity is easily obtained.

Component (D) is at least one selected from the group consisting of monosaccharides, disaccharides, and polysaccharides. The monosaccharides are not particularly limited, and examples thereof include: aldoses, such as glycerylaldehyde, erythrose, threose, ribose, lyxose, xylose, arabinose, allose, talose, gulose, glucose, altrose, mannose, galactose, and idose; and ketoses, such as dihydroxyacetone, erythrulose, xylulose, ribulose, psicose, fructose, sorbose, and tagatose. The disaccharides are not particularly limited, and examples thereof include sucrose, lactulose, lactose, maltose, trehalose, and cellobiose. The polysaccharides are not particularly limited, and examples thereof include glycogen, cellulose, chitin, agarose, carrageenan, heparin, hyaluronic acid, pectin, xyloglucan, and arabinogalactan. The compounds given as examples in the foregoing include those having stereoisomers, and any one of a D form or an L form may be used. Further, as component (D), only one of the components may be used, or two or more of the components may be used in combination. Of those, it is preferred that at least one selected from the group consisting of glucose, fructose, galactose, mannose, and arabinogalactan be used as component (D) because copper powder capable of forming a conductive portion having a low volume resistivity is easily obtained. It is more preferred that at least one selected from the group consisting of glucose, fructose, galactose, and mannose be used as component (D) because the above-mentioned effect is particularly enhanced.

The amount of component (D) to be used is appropriately set in accordance with, for example, the kind of component (D) to be used, and there is no particular limitation on the usage amount. The usage amount is preferably from 0.05 mole to 5.0 moles, more preferably from 0.1 mole to 3.0 moles with respect to 1 mole of component (A). When the usage amount of component (D) falls within the above-mentioned range, copper powder capable of forming a conductive portion having a low volume resistivity is easily obtained.

In the production method of the present invention, the above-mentioned components (A) to (D) are used as essential raw materials, but well-known raw materials (additives) may be further added to the extent that the effect of the present invention is not impaired. Examples of the additives include, but are not particularly limited to, a defoaming agent, a pH adjuster, a specific gravity adjuster, a viscosity adjuster, a wettability improving agent, a chelating agent, an oxidant, a reducing agent, and a surfactant. Further, there is no particular limitation on the usage amount of the additive, but in general, the usage amount is from 0.0001 part by mass to 50 parts by mass with respect to 100 parts by mass of component (A).

Examples of the defoaming agent include 2-propanol, polydimethylsilicone, dimethylsilicone oil, trifluoropropyl methylsilicone, colloidal silica, a polyalkyl acrylate, a polyalkyl methacrylate, an alcohol ethoxylate, an alcohol propoxylate, a fatty acid ethoxylate, a fatty acid propoxylate, and a sorbitan partial fatty acid ester. Of those, it is preferred that 2-propanol be used because the time period up to defoaming is short, and the productivity of copper powder is enhanced.

Examples of the pH adjuster may include a water-soluble basic compound and a water-soluble acidic compound. Examples of the water-soluble basic compound include: alkali metal hydroxides, such as lithium hydroxide, sodium hydroxide, and potassium hydroxide; alkaline earth metal hydroxides, such as calcium hydroxide, strontium hydroxide, and barium hydroxide; alkali metal carbonates, such as ammonium carbonate, lithium carbonate, sodium carbonate, and potassium carbonate; quaternary ammonium hydroxides, such as tetramethylammonium hydroxide and choline; and organic amines, such as ethylamine, diethylamine, triethylamine, and hydroxyethylamine. Of those, it is preferred that an alkali metal hydroxide be used as the pH adjuster because copper powder capable of forming a conductive portion having a low volume resistivity is easily obtained. It is more preferred that sodium hydroxide be used as the pH adjuster because the above-mentioned effect is particularly enhanced.

As the reducing agent, there are given hydrazine and a hydrazine compound.

The method for producing copper powder of the present invention can be performed in accordance with a method known in the art except for using component (A), component (B), component (C), and component (D) as raw materials. Specifically, there is no particular limitation on the method for producing copper powder of the present invention as long as the method includes a step (raw material feeding step) of blending component (A) to component (D), which are essential raw materials, with a solvent, but it is preferred that the method be applied to a wet reduction method. When the method for producing copper powder of the present invention is applied to the wet reduction method, it is only required that a reduction reaction be performed through blending of component (A) to component (D) with a solvent. When an optional raw material such as a defoaming agent is blended, it is only required that the optional raw material be added simultaneously with the essential raw materials or be blended after blending the essential raw materials.

There is no particular limitation on the solvent, but water such as pure water is an optimum solvent.

When each of the raw materials is blended with the solvent, it is preferred that the solvent be controlled to a temperature of from 10° C. to 90° C., and it is more preferred that the solvent be controlled to a temperature of from 40° C. to 70° C. Through setting of the temperature of the solvent within the above-mentioned range, the efficiency of producing copper powder can be enhanced. When the temperature of the solvent is less than 10° C., it becomes difficult to dissolve each of the raw materials in the solvent in some cases.

The pH of the solvent having each of the raw materials blended therein is appropriately adjusted in accordance with the desired shape, particle diameter, and the like of the copper powder. When copper powder having an average particle diameter D₅₀ of from 0.5 μm to 10 μm is produced, it is preferred that the solvent be controlled to a pH of from 8 to 14.

The reduction reaction proceeds when the solvent having each of the raw materials blended therein is heated and held at a temperature of from 50° C. to 90° C. There is no particular limitation on the heating and holding time, but in general, the heating and holding time is from 5 minutes to 120 minutes.

Further, during the reduction reaction, microwave treatment or the like may be performed as required.

Organic substances adhere to the surface of generated copper powder immediately after the reduction reaction, and hence it is preferred that the surface be washed with pure water. Further, copper powder is easily oxidized by air, and hence it is preferred that the surface of the copper powder be treated through use of a fatty acid such as stearic acid immediately after washing.

The copper powder produced as described above can form a conductive portion having a low volume resistivity even when having an average particle diameter D₅₀ of from 0.5 μm to 10 μm. Therefore, the copper powder can be used as a conductive material of a conductive paste for forming a conductive portion (for example, an electrode or a circuit) of an electronic component. The conductive paste can be produced by blending and kneading various additives, for example, a resin such as an acrylic resin or an epoxy resin and a curing agent therefor, with the copper powder.

### EXAMPLES

The present invention is hereinafter described in more detail by way of Examples and Comparative Example. The present invention is by no means limited thereto.

### Example 1

First, 42.0 g of cuprous oxide, 21.6 g of boric acid, and 74.0 g of glucose were added to 74.0 g of pure water, and the mixture was increased in temperature to 50° C. Next, 31.45 g of ammonia water having an ammonia concentration of 28 mass % and 3.52 g of 2-propanol serving as a defoaming agent were further added to the mixture, and the resultant was increased in temperature to 60° C. Then, 70.4 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Example 2

First, 34.0 g of cuprous oxide, 17.5 g of boric acid, 59.9 g of glucose, and 25.42 g of ammonium chloride were added to 59.9 g of pure water, and the mixture was increased in temperature to 50° C. Next, 2.9 g of 2-propanol serving as a defoaming agent was further added to the mixture, and the resultant was increased in temperature to 60° C. Then, 114.0 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Example 3

First, 40.0 g of cuprous oxide, 20.6 g of boric acid, 70.5 g of glucose, and 53.1 g of ammonium bromide were added to 70.5 g of pure water, and the mixture was increased in temperature to 50° C. Next, 3.4 g of 2-propanol serving as a defoaming agent was further added to the mixture, and the resultant was increased in temperature to 60° C. Then, 134.2 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Example 4

First, 45.0 g of cuprous oxide, 23.2 g of boric acid, 79.3 g of glucose, and 39.7 g of ammonium formate were added to 79.3 g of pure water, and the mixture was increased in temperature to 50° C. Next, 3.8 g of 2-propanol serving as a defoaming agent was further added to the mixture, and the resultant was increased in temperature to 60° C. Then, 100.6 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Example 5

First, 45.0 g of cuprous oxide, 23.2 g of boric acid, 79.3 g of glucose, and 48.5 g of ammonium acetate were added to 79.3 g of pure water, and the mixture was increased in temperature to 50° C. Next, 3.8 g of 2-propanol serving as a defoaming agent was further added to the mixture, and the resultant was increased in temperature to 60° C. Then, 100.6 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Example 6

First, 50.0 g of cuprous oxide, 25.7 g of boric acid, and 88.1 g of fructose were added to 88.1 g of pure water, and the mixture was increased in temperature to 50° C. Next, 37.4 g of ammonia water having an ammonia concentration of 28 mass % and 4.2 g of 2-propanol serving as a defoaming agent were further added to the mixture, and the resultant was increased in temperature to 60° C. Then, 83.8 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Example 7

First, 42.0 g of cuprous oxide, 21.6 g of boric acid, and 74.0 g of galactose were added to 74.0 g of pure water, and the mixture was increased in temperature to 50° C. Next, 31.5 g of ammonia water having an ammonia concentration of 28 mass % and 3.5 g of 2-propanol serving as a defoaming agent were further added to the mixture, and the resultant was increased in temperature to 60° C. Then, 70.4 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Example 8

First, 42.0 g of cuprous oxide, 21.6 g of boric acid, and 74.0 g of mannose were added to 74.0 g of pure water, and the mixture was increased in temperature to 50° C. Next, 31.5 g of ammonia water having an ammonia concentration of 28 mass % and 3.5 g of 2-propanol serving as a defoaming agent were further added to the mixture, and the resultant was increased in temperature to 60° C. Then, 70.4 g of a sodium hydroxide aqueous solution having a sodium hydroxide concentration of 50 mass % was further added to the resultant, and then, a reduction reaction was performed with stirring within a temperature range of 75±5° C. for 1 hour. Copper powder generated by the reduction reaction was washed with pure water and dried after being subjected to surface treatment with stearic acid. The obtained copper powder was observed with an FE-SEM to find that the copper powder had a flat shape.

### Comparative Example 1

First, 200 g of copper sulfate pentahydrate (copper raw material) was added to 100 g of pure water, and the mixture was increased in temperature to 50° C. Next, 77.3 g of ammonia water (complexing agent) having an ammonia concentration of 28 mass %, 96.2 g of a sodium hydroxide aqueous solution (pH adjuster) having a sodium hydroxide concentration of 50 mass %, and 9.6 g of 2-propanol (defoaming agent) were further added to the mixture, and the resultant was increased in temperature to 70° C. Next, 57.7 g of glucose dissolved in 57.7 g of pure water was further added to the resultant, and 40.6 of hydrazine monohydrate was further added to the resultant. Copper powder thus obtained was washed with pure water and dried after being subjected to surface treatment with stearic acid. The obtained copper powder was observed with an FE-SEM to find that the copper powder had a spherical shape.

The copper powders obtained in the above-mentioned Examples and Comparative Example were evaluated as follows.

(1) Measurement of Average Particle Diameter D₅₀

An average particle diameter D₅₀ was measured through use of a laser diffraction scattering particle size distribution measurement apparatus (Micro Trac MT-3000 II manufactured by Nikkiso Co., Ltd.).

(2) Measurement of Volume Resistivity

Copper powder and an acrylic resin (BR-113 manufactured by Mitsubishi Rayon Co., Ltd.) were blended in a mass ratio of 4:1 (content of the copper powder: 80 mass %). Toluene serving as a solvent was further added to the mixture, and the resultant was kneaded to obtain a copper paste. The obtained copper paste was applied onto a PET film so as to have a wet film thickness of 10 μm, and fired by heating in the atmosphere at 150° C. for 30 minutes, to thereby obtain a conductive coating film. The obtained conductive coating film was measured for a volume resistivity with a measurement apparatus (Loresta-GP manufactured by Mitsubishi Chemical Analytech Co., Ltd.) by a four-terminal method.

The results of each of the above-mentioned evaluations are shown in Table 1.

TABLE 1

| | D₅₀ | Volume resistivity |
|---|---|---|
| | (μm) | (Ω · cm) |
| Example 1 | 1.8 | 3.6 × 10⁻⁴ |
| Example 2 | 1.8 | 2.0 × 10⁻⁴ |
| Example 3 | 3.3 | 5.1 × 10⁻⁴ |
| Example 4 | 3.1 | 1.2 × 10⁻⁴ |
| Example 5 | 4.0 | 1.2 × 10⁻⁴ |
| Example 6 | 3.0 | 1.4 × 10⁻⁴ |
| Example 7 | 1.8 | 8.0 × 10⁻⁴ |
| Example 8 | 2.2 | 2.7 × 10⁻⁴ |
| Comparative Example 1 | 2.0 | 1.3 × 10⁴ |

As shown in Table 1, the copper powders of Examples 1 to 8 had an average particle diameter D₅₀ within a range of from 0.5 μm to 10 μm, and was able to form a conductive coating film having a low volume resistivity when used in a copper paste.

In contrast, the copper powder of Comparative Example 1 had an average particle diameter D₅₀ within a range of from 0.5 μm to 10 μm, but formed a conductive coating film having a large volume resistivity when used in a copper paste.

As is understood from the above-mentioned results, according to the present invention, a method for producing copper powder capable of forming a conductive portion having a low volume resistivity even when having an average particle diameter D₅₀ of from 0.5 μm to 10 μm can be provided.

The present international application claims priority based on Japanese Patent Application No. 2016-152693 filed on Aug. 3, 2016, the contents of which are incorporated herein by reference in their entirety.

1. A method for producing copper powder, comprising using, as raw materials, (A) cuprous oxide, (B) at least one selected from the group consisting of boric acid and salts thereof, (C) at least one selected from the group consisting of ammonia and an ammonium ion source, and (D) at least one selected from the group consisting of monosaccharides, disaccharides, and polysaccharides.

2. The method for producing copper powder according to claim 1, wherein component (C) is at least one selected from the group consisting of ammonia, ammonium chloride, ammonium bromide, ammonium formate, and ammonium acetate.

3. The method for producing copper powder according to claim 1, wherein component (D) is at least one selected from the group consisting of glucose, fructose, galactose, mannose, and arabinogalactan.

4. The method for producing copper powder according to claim 1, wherein component (B) is boric acid.

5. The method for producing copper powder according to claim 1, wherein the copper powder has an average particle diameter D₅₀ of from 0.5 μm to 10 μm.

6. The method for producing copper powder according to claim 1, comprising using component (B) in an amount of from 0.05 mole to 2.0 moles, component (C) in an amount of from 0.05 mole to 5.0 moles, and component (D) in an amount of from 0.05 mole to 5.0 moles with respect to 1 mole of component (A).
